(19) United States
(12) Patent Application Publication
(10) Pub. No.: US 2016/0224528 A1
(43) Pub. Date: Aug. 4, 2016

(54) Method and System for Collaborative, Streaming Document Sharing with Verified, On-Demand, Freestyle Signature Process

(71) Applicant: Technology Happens LLC, Memphis, TN (US)

(72) Inventors: MICHAEL DAVID TREVARTHEN, Memphis, TN (US); Michael William Blumenthal, Memphis, TN (US)

(21) Appl. No.: 14/618,587

(22) Filed: Feb. 10, 2015

Related U.S. Application Data
(63) Continuation-in-part of application No. 14/610,552, filed on Jan. 30, 2015, now abandoned.

(51) Int. Cl. G06F 17/24; H04N 5/232; G06T 1/00; H04L 29/06; G06F 3/0488

(52) U.S. Cl. CPC G06F 17/242; H04L 63/0861; G06F 3/04883; G06T 1/0007; H04N 5/23222

(57) ABSTRACT

Systems and methods for the sharing, collaborative reviewing and freestyle multiparty signing of an electronic document. The system and method to stream an electronic document from a CSR system onto a touchscreen device for real time and multiple signature placement anywhere within an electronic document. Placement of signature is determined by tapping and holding any point on a document to create a signature box which can be relocated and anchored anywhere on the electronic document. The electronic document is then signed via a touchscreen device and the system captures signature vector-based individual strokes and timing data of the signature strokes and stored with the document. The system uses a camera to take a picture of the signee and embeds the image, time stamp, location, and signature data in the electronic document.

### BACKGROUND OF THE INVENTION

The invention relates to a method and system for facilitating a real time, streaming document sharing with on-demand, freestyle signature process.

Reviewing a document and applying a signature, by way of writing one's name, one's initials, or other mark uniquely associated with an individual to a document has long been recognized as a way to acknowledge and accept terms of an agreement. With the introduction of computers and electronic documents, signing and verifying electronic documents has become a standard method for conducting business. While working with electronic documents often makes a process more efficient and economic, working with electronic documents can also create challenges, specifically when dealing with document review and signature authentication and verification.

Computers have resulted in electronic documentation. Contracts, proposals, business plans and any type of paper document can now be an electronic document. Paper reduction efforts have encouraged a trend away from paper documents and towards electronic documents. Electronic documents can be created by various means such as scanning a paper document, taking a digital picture of a paper document or writing directly in electronic form using word processing or other software. Once an electronic document has been formed, it can be easily sent electronically using a method such as email or shared and viewed simultaneously.

Initially, an electronic document signing process required three steps: 1) printing the electronic document 2) signing the document and 3) (re)creating an electronic document (e.g. scanning the signed document). This process was cumbersome. An alternative called for a creation of a signature file, which could be placed anywhere on the electronic document and then embedded into the electronic document when saved. Another alternative to the three step process called for a creation of an electronic document with predefined input fields into which a signature could be typed.

A benefit of creating a signature file and affixing said signature file to a document is that it does not depend on predefined fields in the electronic documents when signing. However, while less cumbersome than printing, signing and rescanning an electronic document, a signature file still has drawbacks. Breaches in security can grant an unintended third party access to a signature file. Once a third party has access to a signature file, the third party can sign a document on behalf of the signature file owner. Additionally, while signing a document with a signature file allows a signature to be placed throughout an electronic document and reused as needed, access to the signature file is needed to affix a signature to a document. As the signature file is often stored in the cloud and accessible through the Internet, access is not always available. For example, if a signature is needed on an electronic document in a closed system or one without Internet access, a signature file cannot be used. A reusable signature can also raise doubts as to who actually applied the signature file to a document. As mentioned, it is possible for someone to sign a document simply by having access to the signature file. Additionally, an authorized individual can inadvertently, through a misunderstanding or otherwise, sign an electronic document on someone else's behalf. Finally, a signature file is still cumbersome because it is a two-step process: 1) the signee needs to locate a signature file and 2) apply it to an electronic document.

Electronic documents with predefined fields are electronic documents which have tags or other indicators defining the location and size of signature boxes where an individual can sign or initial (henceforth predefined electronic documents). Early versions of predefined documentation were not able to capture actual strokes of a signature, rather a signee typed his or her name into a predefined field. Typing a signature records no individual characteristics of the signature and therefore signature verification is limited. Additionally, the same concerns with authenticity and confusion described above and which exist for signature files, exist with typing a person's signature into a predefined field.

Signature pads alleviate the problem of not having access to a signature file in a closed system, allow for real time signing and alleviate concerns regarding authenticity when compared to typing a signature into an electronic document with predefined fields. A signature pad in conjunction with human interaction (ID verification) can increase the likelihood of signature authenticity. With the introduction of signature pads, signatures can now be affixed to electronic documents in real time and incorporate a person's unique writing style. Signature pads require electronic documents to have predefined fields, thus again limiting the signature to a predefined location.

Any documents requiring additional signatures require reprogramming of an electronic document to define additional signature fields. The requirement of having signature fields predefined limits the ability to modify a document signature field while working with a customer. Examples of two limitations of modifying an electronic document with predefined fields is that an individual needing to add a signature field often does not have the skill set to add additional signature fields and, often, as a matter of company policy, an organization does not grant the individual working with a customer the authorization to modify an electronic document due to the risk of inadvertently modifying contractual language. Therefore an electronic document with predefined fields is both cumbersome and can decrease economic efficiency by delaying business transactions. While signature pads, through the ability to capture the actual image of a signee's signature, provide one means of authenticity, signature pads also create a new problem, namely, when signing a signature pad, the signee does not see the actual document being signed. Because a signee does not see the actual document, the document is often read to a signee and as a result, questions as to whether the agreement was fully understood can arise. Finally, because a signee does not see and therefore does not sign the document directly, a signee can question whether the document purportedly read to a signee, was the one signed.

Replacing signature pads with touchscreen devices addresses a signee's concern with affixing a signature to a document which is never seen. Incorporating touchscreen devices when signing electronic documents allows a signee to view and sign the viewed electronic document. Throughout the signing process, the signee sees an electronic document. Touchscreen solutions allow a signee to sign and initial anywhere on a document and therefore are not dependent on electronic documents with predefined fields for signing or initialing a document. While touchscreens address the signature pad concern regarding which electronic document has been signed, it does not address the concern regarding whether a signee understands a document or that an organization reviews a document fully with the signee. Additionally, a touchscreen solution cannot protect an individual from being impersonated through the use of false identification documents.

The present invention is designed to allow documents and other content which can be rendered on a computer to be shared to a second touch capable screen for collaborative review by more than one individual and provide the ability to easily accept multiple, secure digital signatures on the document being shared. The present invention is a plug and play solution replacing current signature pad systems and was developed to address a need for increased efficiency and security in the banking industry. The present invention consists of an external hardware device with proprietary software and peripherals to support customer interaction. The proprietary software facilitates real time electronic communication and interaction between a company network and customer interfaces.

The present invention alleviates the dependence on predefined electronic documents, ensures that the signee has reviewed the signed document with a company representative, such as a Bank Teller or Customer Service Representative (CSR), prior to signing, assures that specific clauses are reviewed, can verify that a signee indicated (through initials or other personal unique markings) that each clause has been understood and reduces the risk fraud by recording an image of the individual signing an electronic document. The present invention alleviates dependence on predefined electronic documents by supporting signature box generation anywhere on an electronic document. By simultaneously projecting an electronic document on CSR and signee display screens and translating either user's actions to the other's screen in real time, the CSR can be assured that the agreement and each clause the CSR reviewed was also simultaneously reviewed by the signee. A company or CSR can require a signee to initial any clause indicating that the clause was explicitly and fully explained to the signee. During the signing process, the present invention can record images of the signee which reduces the threat of fraud due to Member impersonation.

### BRIEF SUMMARY OF THE INVENTION

A system and method for real time electronic document signing and authentication is disclosed. This invention enables a Customer Service Representative (CSR) to review an electronic document with a third party (Member) signee in real time, highlight portions of the electronic document and sign or initialize the electronic document anywhere without electronic document pre-programming or the use of a signature file and then record an image of the person signing the electronic document. As stated previously, currently organizations use signature pads for electronic signatures. The present invention is designed to replace signature pad methods and systems. When replacing a signature pad method and system with this invention, actions taken by the CSR are relatively unchanged. A CSR will still retrieve an electronic document from CSR Infrastructure (company network) and prepare an electronic document for a Member. When an electronic document is ready for a Member's review and signature, the present invention will be implemented. While the CSR process will incorporate a more detailed document review process and may or may not require slight changes, CSR actions are relatively unchanged while the invention provides improved security and adds significant value to the overall signature process.

In an embodiment the present invention provides a method for applying a signature in real time on an electronic document displayed simultaneously on a CSR display and a Member display without predefined reference points or the use of a stored signature file. An electronic document is displayed on a CSR computer display and simultaneously projected on a Member Touchscreen Device via hardwire, Bluetooth, Wi-Fi, NFC or other wireless technology. Because the electronic document is located on the CSR workstation and projected to the Member Touchscreen Device, actions by either the CSR or Member are simultaneously shown on both displays. User actions are recorded in the CSR workstation's temporary storage and the changes are immediately projected from the CSR workstation onto the Member Touchscreen Device. Member actions on the Member Touchscreen Device are captured via software running on an external hardware device and CSR actions are captured via software running on a CSR workstation. Either a Member or CSR can indicate a desired location for a Member to initial or sign a document by pressing and holding a mouse button (for the CSR) or pressing and holding a finger or stylus on the Member Touchscreen Device. A signature box is then generated at the indicated location based upon a predefined set of rules. The size of the signature box can be based on screen size and resolution, allows adequate room to place the signature and can be zoomed in or out depending on user preference. Additionally, the signature box can be moved or deleted by a user if needed. After the signature box has been placed in the correct location, a Member signs or initials the document within the signature box. Signature data, such as vector-based individual strokes and/or stroke timing data, can be collected and embedded within the electronic document along with an image or video of the Member. The captured data is integrated into the electronic document when the Member accepts the signature. Video and image captures can be specified to coincide with Member actions at the beginning, during, and end of the signature process or a combination thereof. For example, the Member can be photographed or recorded on video when the Member accepts the signature, when the Member begins to sign, at timed intervals or whenever the Member touches the Member Touchscreen Device with a finger or stylus after the signature box has been created.

In an embodiment, the present invention provides a system for embedding a written signature into an electronic document. The system displays an electronic document on a CSR computer display and simultaneously projects, through an external hardware device running proprietary software d connected via a hardwire, Bluetooth, Wi-Fi, NFC or other wireless technology, the same electronic document on a Member Touchscreen Device. A signature field creator module is configured to create a signature field on an electronic document. A Member Touchscreen Device is used to display and support user interactions with an electronic document, the signature field creator module, and other software modules. A software module is configured to record a user's signature on a Member Touchscreen Device. A signature data point module is configured to record signature data points such as vector-based individual strokes and signature stoke timing data. A proximity sensor is configured to detect the presence of a user and will shut the system down should the user leave a predefined proximate area. A camera is configured to enable the System to record images or video of a user during the signing process and a software module is configured to record the date and time a signature is accepted by a user. Alternatively, one device could incorporate two or more of the following: External Hardware Device, Member Touchscreen Device, camera and/or proximity sensor. A software module is configured to record the location (specific device) of the installed System (hardware) where a signature is executed. An embodiment of the system wherein an external hardware device with proprietary software is used to communicate with CSR Infrastructure. During an idle state, the present invention can project marketing material onto the Member Touchscreen Device. Marketing materials can include promotions for additional company services or third party materials.

Other aspects of the invention will become apparent by consideration of the detailed description and accompanying drawings.

Additional features and advantages of the invention will be apparent from the detailed description which follows, taken in conjunction with the accompanying drawings, which together illustrate, by way of example, features of the invention; and, wherein:

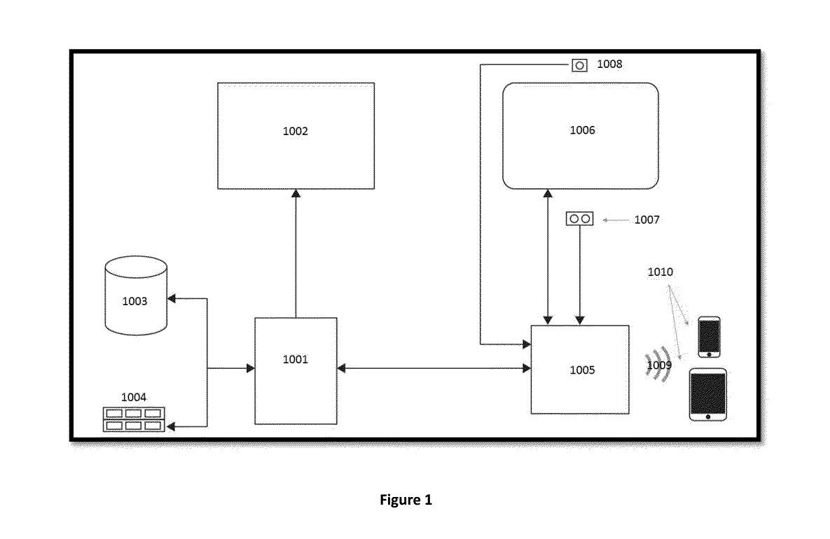

FIG. 1 is an illustration of components of the system in accordance in accordance with an embodiment of the present invention.

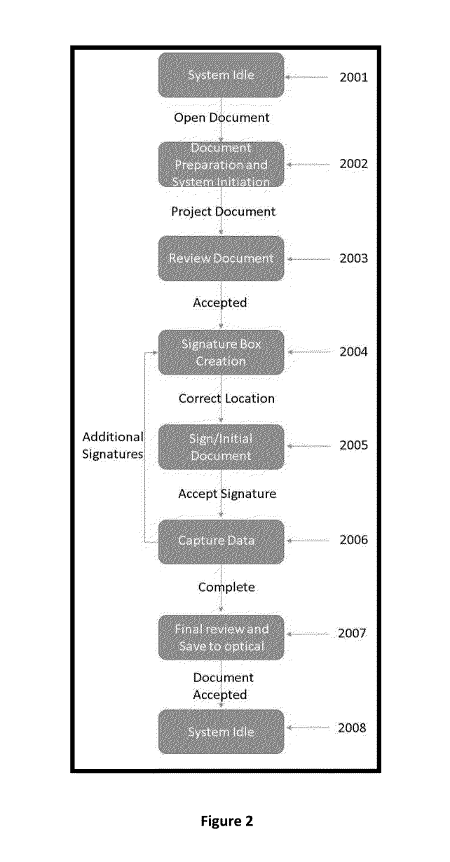

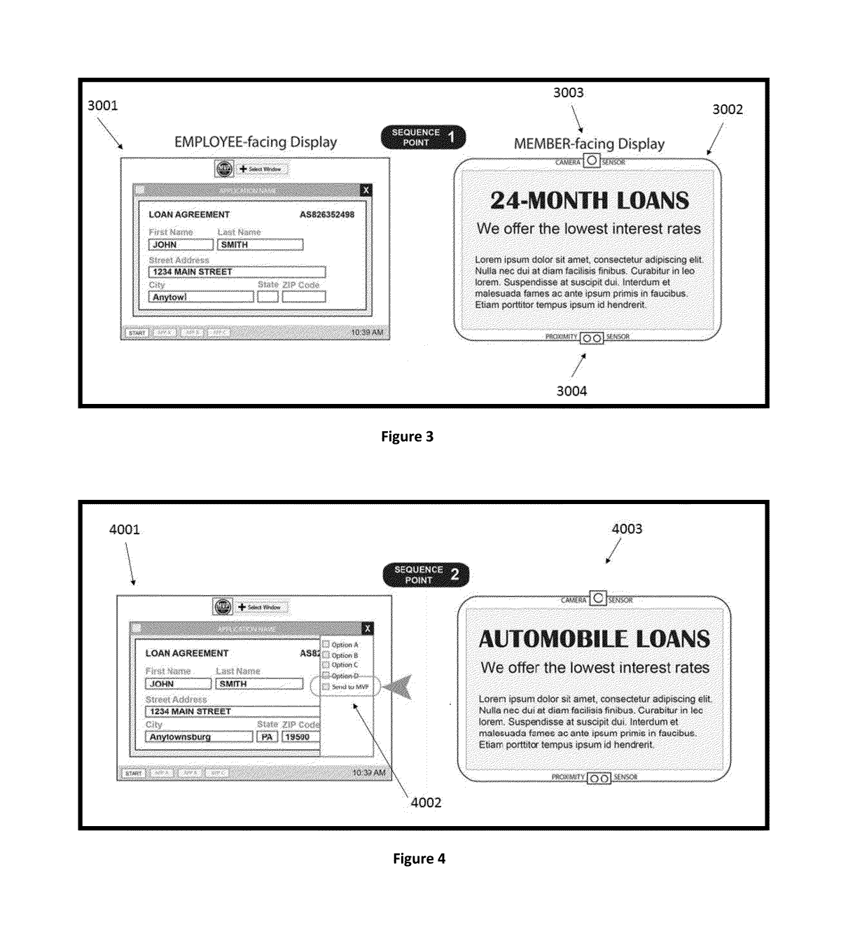

FIG. 2 is an illustration of the behavioral diagram of the process. Each step is further detailed in FIGS. 3 through 10.

FIG. 3 (Sequence Point 1) is an illustration of a CSR and a Member Touchscreen Device when the system is inactive in accordance with an embodiment of the present invention.

FIG. 4 (Sequence Point 2) is an illustration of a CSR Screen and Member Touchscreen Device once a CSR has prepared an electronic document and is ready to activate the System in accordance with an embodiment of the present invention.

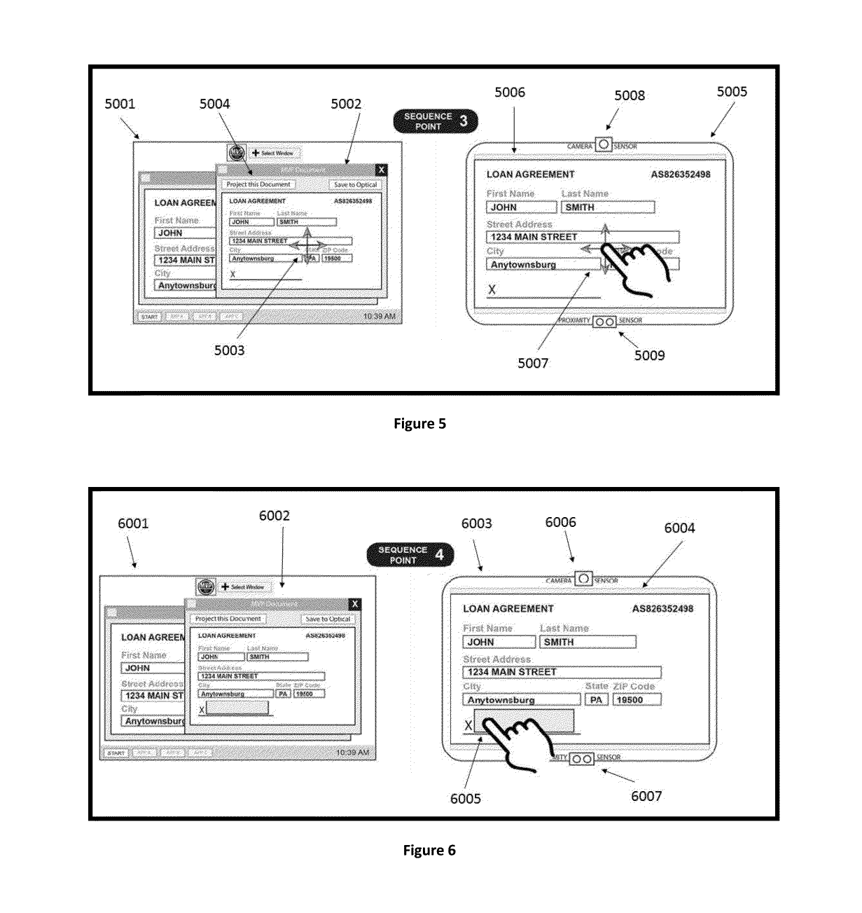

FIG. 5 (Sequence Point 3) is an illustration of a CSR Screen and Member Touchscreen Device as a Member interacts with an electronic document in accordance with an embodiment of the present invention.

FIG. 6 (Sequence Point 4) is an illustration of a CSR Screen and Member Touchscreen Device as a Member generates a signature box in accordance with an embodiment of the present invention.

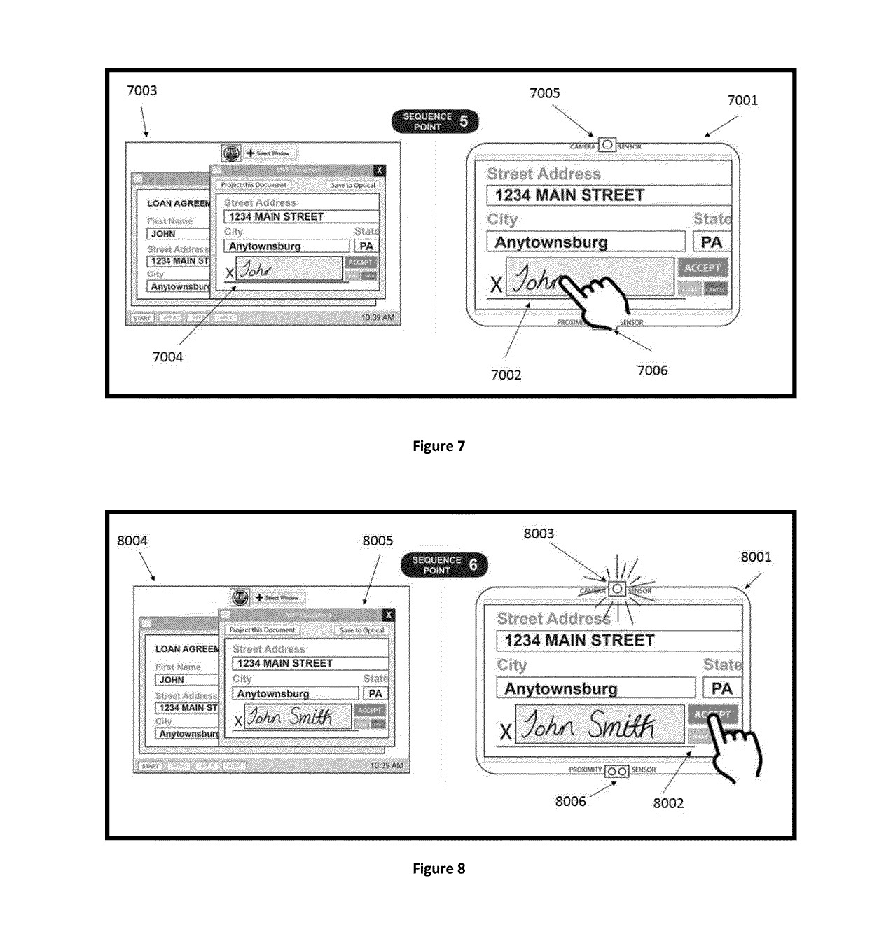

FIG. 7 (Sequence Point 5) is an illustration of a CSR Screen and a Member Touchscreen Device as a Member is signing an electronic document in accordance with an embodiment of the present invention.

FIG. 8 (Sequence Point 6) is an illustration of a CSR Display and Member Touchscreen Device when a Member selects to accept the signature in accordance with an embodiment of the present invention.

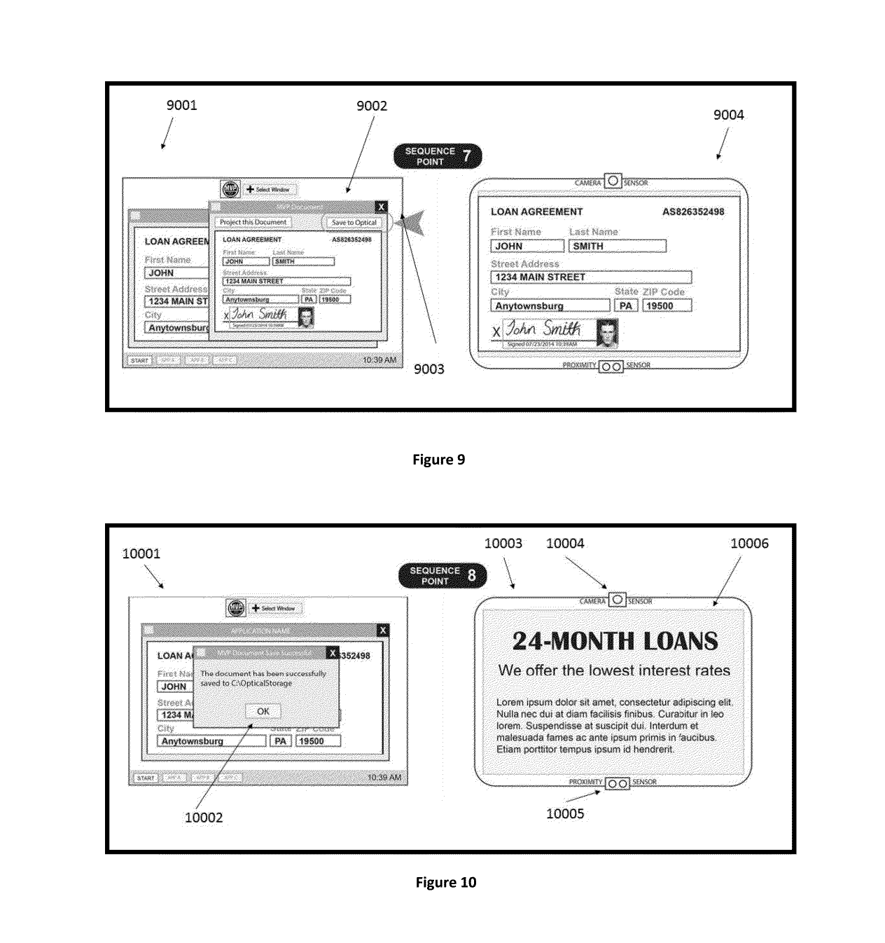

FIG. 9 (Sequence Point 7) is an illustration of a finalization process in accordance with an embodiment of the present invention.

FIG. 10 (Sequence Point 8) is an illustration of a Member Touchscreen Device as a System returns to an idle state in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF THE INVENTION

Embodiments of the invention are discussed below with reference to the Figures. Those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternatives embodiments do not necessarily imply that the two are mutually exclusive. When a particular type of organization (e.g. a bank) is mentioned, the organization mentioned is for example purposes and does not imply that the present invention is limited to a banking organization. The detailed descriptions given are for explanatory purposes and extend beyond the embodiments of the invention. For example, FIG. 1 is an illustration of a suitable system in which embodiments of the invention may be implemented and those skilled in the art will recognize that the invention may also be implemented in combination with different CSR Infrastructure and depending on the specific needs or preferences of an organization, the invention itself may be comprised of different components (e.g. a tablet device with a built in camera and motion sensor vs. a separate camera and motion sensor).

FIG. 1 is an illustrative view of the invention. Items 1001-1004 shows typical infrastructure components of a CSR organization. The present invention is not dependent on a specific CSR Infrastructure composition, so long as the present invention software component can be successfully installed and run on the CSR Infrastructure. Plugins to support different operating systems and editing software can be developed depending on the needs of an organization. The present invention connects to a CSR workstation and replaces an organization's signature process, including hardware and software. Within a CSR's Infrastructure, a CSR works primarily on a single independent processing unit 1001. A CSR views an electronic document on a Monitor/Display Screen 1002. Components 1001 and 1002 together are generally referred to as a workstation or personal computer. CSR Infrastructure will include an Optical Storage System 1003 for backing up and storing files along with a Server or Network and other Resources 1004, which store company documentation and allow a CSR to access files, forms and other company resources. Components 1003 and 1004 are external to the work station. Electronic documents utilized by the CSR can be retrieved and stored on the network 1004. In the present invention proprietary software is installed and run on the central processing unit 1001. During collaboration, a working document is created and stored on the CSR workstation's hard drive as a temporary file. Because the electronic document is located on the CSR workstation and projected to the Member Touchscreen Device 1006, actions by either the CSR or Member are simultaneously shown on both displays 1002, 1006. User actions are recorded in the CSR workstation's temporary storage and the changes are immediately projected from the CSR workstation onto the Member Touchscreen Device.

The essential circuit of the present invention consists of a proprietary software application, which is executed on a CSR workstation 1001, along with the External Hardware Device 1005 which is also running proprietary software (CLIENT) and is connected to the CSR's central processing unit 1001. The External Hardware Device 1005 is a small computer utilizing a microprocessor running the Client Application (CLIENT) on top of a custom build of the Linux operating system.

The software of the present invention running on the CSR central processing unit 1001 provides a server, to which the CLIENT Application running on the External Hardware Device 1005 connects. This client/server connection uses TCP/IP protocols to transmit data in both directions. The connection between the work station and the External Hardware Device can be a USB cable. The External Hardware Device 1005 draws its power, from the CSR computer, through a USB cable. If the power at the CSR's USB port is insufficient or the connection is through some other means (e.g. wireless), a 5V Micro USB power adapter can be connected to the External Hardware Device 1005 to supply power from a standard AC power plug.

The Member Touchscreen Device 1006 is connected to the External Hardware Device 1005 via a VGA/DVI/HDMI/Display Port cable. The Proximity Sensor 1007 is connected to the External Hardware Device via an axial cable/M8/M12 connector and the Camera 1008 is connected to the External Hardware Device 1005 through a USB connection. Wireless handheld devices 1010 are connected to the External Hardware Device by a secured Wi-Fi Direct protocol standard 1009. A custom built mobile application running on the wireless device performs a security handshake with the External Hardware Device. Once authenticated, the mobile application will serve the purpose of the otherwise “wired” Member Touchscreen Device.

FIG. 2 illustrates an example of an overall behavioral flow of a signature process. This figure is designed to provide a brief overall step by step explanation of a signature process. Each step, 2001-2008, is further explained in detail in FIGS. 3-10 in ascending order (e.g. FIG. 2, Number 2001 corresponds with FIG. 3, FIG. 2, Number 2002 corresponds with FIG. 4, etc . . . )

Prior to a Member arrival, the present invention is at an idle state 2001. During the idle state, the present invention projects advertisements or other materials onto the Member Touchscreen Device. When a Member requests a service or transaction requiring a contract or other documentation, a CSR will open and prepare a document. Once prepared, the CSR will initiate the present invention 2002 by opening the prepared document in the present invention software application running on the CSR work station and projecting the document to the Member Touchscreen Device. Once the electronic document is projected to the Touchscreen Device, the CSR and Member will review the document together 2003 in a collaborative manner. Once the document has been reviewed and is ready to sign, the Member or CSR will select a location on the document to apply a signature 2004. A CSR indicates a location for a signature box by placing a mouse cursor at the desired signature location and then clicking and holding a mouse button. A Member indicates a location for a signature box by pressing and holding a finger or stylus on the Member Touchscreen Device. As a result of the click or press and hold action, a signature box is generated. If the signature box is not in the correct location the CSR or Member can drag the signature box to the correct location or cancel the signature box and generate another one at the correct location.

Once the signature box is in the correct location, the Member signs or initials the electronic document with a finger or stylus 2005. The CSR or Member will click “Accept” to approve the signature. As the signature is accepted, the signature, signature data and images and/or video is captured and stored on the CSR workstation as temporary storage 2006. At this point, additional signatures and initials can be applied by creating additional signature boxes 2004. When all signatures and initials have been added to the document, the CSR and Member will make a final review and then the CSR will save the document to the optical drive 2007. Once the file has been saved to the optical drive, the system returns to an idle state 2008.

FIGS. 3 through 10 are step-by-step Behavioral Diagrams illustrating the present invention. The first and last Figures (FIG. 3 and FIG. 10) show the present invention in an idle state. The Behavioral Diagrams, FIGS. 3 through 10, show the present invention in an idle state, the initialization process, utilization and then return to an idle state.

FIG. 3 is an example of the System in an idle state. A CSR opens a file needed to complete a transaction for a Member on the CSR Computer 3001. Streaming marketing material is displayed on the Member Touchscreen Device 3002 while the CSR Display shows no indication the present invention is active, though software is running in background on the CSR workstation. The streaming marketing data is managed by the proprietary software installed on the CSR workstation. There is no interaction between the Member and CSR Infrastructure. The System's Camera 3003, the Member Touchscreen Device 3002 and the Proximity Sensor 3004 are disabled.

FIG. 4 illustrates activating the System. When a CSR is finished preparing an electronic document on the CSR display screen 4001 and it is ready for a Member's review, the CSR will initiate the System by selecting “Send to MVP” 4002. Alternatively, software applications can be made to communicate directly with the present invention software running on a CSR workstation either through built-in support, by installing plug-ins created specifically for an application to support integration or a custom software printer driver. Acrobat PDF files can be opened directly into the present invention software application. Up until this step, the System continues to stream marketing materials on the Member Touchscreen Device 4003. As the CSR selects “Send to MVP”, the camera, proximity sensor and Member Touchscreen Device will become active. From this point forward, the present invention is in an active state.

FIG. 5, illustrates the projection and real time relationship between the CSR display 5001 and Member Touchscreen Device 5005. Once a CSR selects “Send to MVP” as described in the previous FIG. 4, the document is initially transferred to the present invention software application (MVP) running on the CSR workstation, a new file is created and saved to a temporary (working) location on the CSR's workstation local storage and then opened in the MVP application. The electronic document itself is not transferred, rather an image of the document is projected onto the Touchscreen Device. Depending on pre-defined user preference settings within the MVP application the document can automatically be projected onto the Member Touchscreen Device 5005 or, if not automatically projected, the CSR can choose to project it at any time 5004. Once the electronic document is projected onto the Member Touchscreen Device 5005, the Member Touchscreen Device 5005 unlocks to allow Member interaction and the Camera Sensor 5008 and the Proximity Sensor 5009 are enabled (if previously disabled).

When a document is projected from the CSR workstation to the External Hardware Device, the exact view of the MVP application window 5002 displaying the current document file is mirrored to the CLIENT software running on the External Hardware Device. The MVP application window content from the CSR Display Screen is first encoded into H.264 video data by the MVP application on the CSR workstation and then streamed to the Client running on the External Hardware Device in near real-time. The Client on the External Hardware Device decodes this stream and displays the document 5006 on the Member Touchscreen Device 5005 (or wirelessly connected device). Touch gestures 5007 can be used to navigate through and change the zoom level of the document. A tap or click gesture on the document translates into a brief circular queue to illustrate a targeted position. Touch gestures and other interactions by the Member with the Member Touchscreen Device are decoded by the Client running on the External Hardware Device. Member Touchscreen Device gestures are messaged back through the Client and displayed on the document 5003 in the CSR application window 5002. The resulting Member navigation gestures 5007 (scroll, zoom, etc . . . ) are observed in real-time by the Member through the image which is being streamed to the External Hardware Device from the CSR workstation and displayed on the Member Touchscreen Device 5005, 5006. A CSR can also navigate the electronic document by using mouse controls. The CSR interacts with the document directly and the CSR interactions are streamed to the Member Touchscreen Device 5005. This two way control allows collective collaboration between a Member and CSR while reviewing an electronic document.

FIG. 6 illustrates signature box generation. To generate a signature box, a Member can tap and hold a finger or stylus on a Member Touchscreen Device 6003 anywhere in the Electronic Document 6004. Alternatively, the CSR can generate a signature box by positioning a mouse cursor at a desired location and then clicking and holding a mouse button. The System then creates a signature box at the location of the finger, stylus or mouse cursor 6005. The signature box can be repositioned by sliding the finger, stylus or mouse cursor before releasing. Once releasing, the System anchors the signature box to the location on the document and visually zooms the signature box based on screen size and resolution. During this process, the Member's proximity is monitored via the Proximity Sensor 6007. Should the Member move outside a predefined area proximate to the sensor, the Member Touchscreen Device will return to an idle state and be disabled. If configured, a live image of the Member can be displayed on the CSR Display 6001 via the Camera 6006. A signature box can be generated anywhere and be placed anywhere on the electronic document, without the need to have previously hard-coded a pre-determined signature box into the document.

When a signature box is inserted into the document, both the Member and the CSR interfaces 6002, 6004 communicate and synchronize with each other via a messaging system between the Client on the External Hardware Device and the MVP Application on the CSRs workstation. Control is rendered separately on each side (CSR and Member). When changes are made to the signature box on one side, those changes are messaged back to the other side and the rendering of the signature boxes are updated accordingly to stay synchronized. Communication and updating is bidirectional, allowing either side to be manipulated and reflect its changes to the other side. Until accepted, these synchronized signature boxes are rendered as overlays on top of the actual document preview or, in the case of the projected view, the streamed view canvas.

FIG. 7 illustrates a Member signing an electronic document. As a Member signs an Electronic Document 7002 via the Member Touchscreen Device 7001, the Client on the External Hardware Device translates the actions to and shows the progress on the CSR Display 7003 in a MVP application window 7004. The Proximity Sensor 7006 confirms that the Member is and ensures the Member remains in predefined area of the Member Touchscreen Device 7001. The Camera 7005 can show the Member while the Member signs the document. Additionally, signature data such as vector-based signature stroke data and signature timing data can be collected. The present invention supports multiple signatures, as many as are desired, and supports signature box generation and placement anywhere on the electronic document. No tag or document pre-programming is necessary.

FIG. 8 illustrates signature confirmation. When clicking the “Accept” button 8002 displayed on the Member Touchscreen Device 8001, a picture is taken via a camera 8003 and all of the signature data (vector and timing information, timestamp, photo, video, etc.) for the current signature (or initialization) is encrypted and inserted into the document as non-visual, embedded data and a graphical representation of the signature is constructed and permanently placed into position within the electronic document and the updated version of the file is saved to the same temporary (working) location on the CSR's workstation. The signed document is displayed on the CSR display screen 8004 in the MVP application window 8005. An updated version of the file is saved to the working location on the CSR workstation. At this stage, the signature process may begin again at a different location within the document, and can occur as many times as needed. After a signature has been accepted or cancelled 8002, the document zooms back to its previous viewing level, document manipulation is enabled and additional signatures or initials may be added throughout the document.

FIG. 9 illustrates signature finalization. Via the CSR's Display Screen 9001, the CSR makes a final review of the signed electronic document in a MVP application window 9002. When satisfied, the electronic document is saved to the optical drive 9003 in a location which is either chosen by the user, or is determined by a predefined location (preference). The collected data for all inserted signatures is encrypted and embedded into the electronic document, establishing a binding relationship between all elements—if any single element of the document is modified after this encryption/binding is complete, the integrity of the document is considered invalid. During the final review and save to optical drive, the Client software on the External Hardware Device continues to project the electronic document onto the Member Touchscreen Device 9004.

FIG. 10 illustrates confirmation that the electronic document has been successfully saved and a return to the idle state. Once the electronic document is saved to optical drive, the MVP application window is closed and replaced by a “Saved Conformation Window” 10002 on the CSR's Display Screen 10001. The Member Touchscreen Device 10003, Camera 10004 and Proximity Sensor 10005 are deactivated and marketing material 10006 is again displayed. The present invention is in an idle state.

1. A method for applying a signature in real time on an electronic document displayed simultaneously on a CSR display and a system display without predefined reference points or the use of a stored signature file, comprising:
displaying an electronic document on a CSR computer display simultaneously projecting said electronic document on a touchscreen device;
capturing a user's action via said touchscreen device;
indicating a desired location on the displayed electronic document for the signature;
the system generating a signature box at said desired location;
analyzing the user's actions via a set of rules which indicate the desired location for the user's signature;
generating a signature box in which the signee enters signee's signature;
capturing signature;
anchoring signature to location as specified by user; and
integrating signature into the document.

2. A method as in claim 1, wherein the system displays marketing materials on the touchscreen while the System is idle;

3. A method as in claim 1, wherein in the electronic document is manipulated by the CSR's actions within the CSR Infrastructure and said actions are translated to the System touchscreen.

4. A method as in claim 1, wherein the electronic document is manipulated by the Member's actions on the touchscreen and translated to the CSR Display.

5. The method as in claim 1, wherein the CSR indicates the place for a signature or initial by pressing and holding a mouse button.

6. A method as in claim 1; wherein the System zooms the signature box to a size based on screen size and resolution;

7. The method as in claim 1, wherein the Member indicates the place for a signature or initial on the touchscreen by pressing and holding a point on the touchscreen.

8. The method as in claim 1, wherein an electronic document is displayed on a CSR display and simultaneously streamed to a touchscreen display via Bluetooth, Wi-Fi, NFC or other wireless technology or hardwired technology.

9. The method as in claim 1, wherein an electronic document is displayed on a CSR display and simultaneously streamed to a Member personal touchscreen device via Bluetooth, Wi-Fi, NFC or other wireless technology or hard wired technology.

10. The method of claim 1, comprising: the capturing of signature data such as the vector-based individual strokes along with their timing data and storing them within the signed document.

11. The method of claim 1, comprising: the capturing of signee image via a camera and storing the photograph within the signed document when the Member accepts the signature.

12. A method as in claim 1, wherein the camera captures the image of the signee when the signee first begins the signature and storing the photograph within the signed document when the Member accepts the signature.

13. The method as in claim 1, wherein the signee is captured via multiple photographs, taken at timed intervals, and storing the photographs within the signed document when the Member accepts the signature.

14. The method as in claim 1, wherein the system signee is captured via a series of photographs taken each time the signee touches the touchscreen with finger, stylus or other device and said photographs become part of the document. The system begins to take pictures of the signee when the signature box is created and stops taking photographs when the user accepts the signature.

15. The method as in claim 1, wherein the signee is captured via video recording beginning when the signature box is created and stops recording when the user accepts the signature and storing the video within the signed document when the Member accepts the signature. Said video is embedded into and becomes part of the signed electronic document.

16. The method as in claim 1, wherein the signee is captured via video recording beginning when the System is initiated and ending when the user accepts the signature. Said video is embedded into and becomes part of the signed electronic document.

17. A system for embedding a written signature into an electronic document, comprising:
a module configured to project an electronic document from CSR infrastructure to an external system;
a module configured to communicate between CSR Infrastructure and the System;
a module configured to translate user actions on the System to CSR Infrastructure;
a signature field creator module configured to create a signature field on an electronic document;
a touchscreen to display and support user actions with said projected electronic document, support said signature field creator module, and other user actions;
a module configured to record a user's signature on the touchscreen;
a signature data point module configured to record signature data points;
a proximity sensor configured to detect the presence of a user;
a camera configured to enable the System to photograph a user;
a module configured to record the date and time a signature is accepted by a user;
a module configured to record the location of the installed System (hardware) where a signature is executed;

18. The system as in claim 17 wherein an external hardware device with proprietary software is used to communicate with CSR Infrastructure;

19. The system as in claim 17 wherein the camera is used to record images and/or video of a user during signing;

20. The system as in claim 17 wherein the signature data point module is configured to collect data on vector-based individual strokes and timing data of the signature strokes;
